(19) United States
(12) Patent Application Publication
(10) Pub. No.: US 2025/0033732 A1
(43) Pub. Date: Jan. 30, 2025

(54) BICYCLE FORK ASSEMBLY INCLUDING STEER-LIMITING MECHANISM

(71) Applicant: PON Bicycle I B. V., Almere (NL)

(72) Inventors: Anton PETROV, Lake Forest, CA (US); Robert James PIKE, Caesarea (CA)

(21) Appl. No.: 18/358,487

(22) Filed: Jul. 25, 2023

(51) Int. Cl. B62K 3/02

(52) U.S. Cl. CPC B62K 3/02

(57) ABSTRACT

A front fork assembly for a bicycle is configured to be rotatably coupled to a head tube of the bicycle, such that the fork assembly is configured to rotate relative to the head tube about an axis of rotation. The fork assembly may include a C-shaped fork body having a front member connecting an upper portion and a lower bearing surface of the fork body. The fork assembly may include a tension rod extending from the upper portion to the lower bearing surface through an aperture of an inner wall of the head tube at a position offset from the axis of rotation, such that the tension rod is configured to move with rotation of the fork body. The aperture is configured to limit a range of motion of the tension rod and therefore of the front fork.

### FIELD

This disclosure relates to systems and methods for fork assemblies of bicycles. More specifically, the disclosed embodiments relate to fork assemblies including steer limiting mechanisms.

### INTRODUCTION

The fork assembly of a bicycle may have a large impact on the performance of the bicycle. The fork assembly couples the handlebars to the front wheel, and therefore may impact handling performance of the bicycle. Additionally, the fork assembly impacts the aerodynamic performance of the bicycle, because the fork assembly is disposed at a front portion of the bicycle.

### SUMMARY

The present disclosure provides systems, apparatuses, and methods relating to a bicycle fork assembly including a steer-limiting mechanism.

In some examples, a bicycle includes: a frame including a head tube; a fork assembly coupled to the head tube and configured to rotate relative to the head tube about an axis of rotation, wherein the fork assembly includes: a fork body having an upper portion interfaced with an upper end of the head tube, a lower bearing surface interfaced with a lower end of the head tube, and a front member connecting the upper portion and the lower bearing surface, the front member disposed forward of a front surface of the head tube; and a tension rod extending from the upper portion to the lower bearing surface through an aperture of an inner wall of the head tube at a position offset from the axis of rotation, such that the tension rod is configured to move with rotation of the fork body; wherein the inner wall is oriented transverse to the axis of rotation and the aperture is configured to limit a range of motion of the tension rod.

In some examples, a fork assembly for a bicycle includes: a C-shaped fork body configured to be coupled to a head tube of a bicycle, wherein the fork body includes an external front member spanning between an upper portion configured to interface with an upper end of the head tube and a lower bearing surface configured to interface with a lower end of the head tube; and a tension rod extending from the upper portion to the lower bearing surface, wherein the external front member and the tension rod are disposed on opposite sides of an axis of rotation of the fork body.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is an isometric view of an illustrative bicycle including an illustrative bicycle frame, fork assembly, and handlebar stem in accordance with aspects of the present disclosure.

FIG. 2 is an exploded view depicting the bicycle frame, fork assembly, and handlebar stem of FIG. 1 in accordance with aspects of the present disclosure.

FIG. 3 is an isometric view of the illustrative fork assembly of FIG. 1 in accordance with aspects of the present disclosure.

FIG. 4 is an exploded view of the illustrative fork assembly of FIG. 3 in accordance with aspects of the present disclosure.

FIG. 5 is a perspective view of an illustrative tension rod and preload insert of the fork assembly of FIG. 3 in accordance with aspects of the present disclosure.

FIG. 6 is an isometric view of the preload insert and tension rod of FIG. 5 connected to the bicycle frame of FIG. 1 in accordance with aspects of the present disclosure.

FIG. 7 is an isometric view of the fork assembly, bicycle frame, and handlebar stem of FIG. 1 in accordance with aspects of the present disclosure.

FIG. 8 is an isometric view depicting the fork assembly of FIG. 1 rotated relative to the bicycle frame of FIG. 1 in accordance with aspects of the present disclosure.

FIG. 9 is a second exploded view depicting the illustrative bicycle frame, fork assembly, and handlebar stem of FIG. 1 in accordance with aspects of the present disclosure.

FIG. 10 is a bottom view of an illustrative head tube of the bicycle frame of FIG. 1 depicting an illustrative steer limiting aperture in accordance with aspects of the present disclosure.

### DETAILED DESCRIPTION

Various aspects and examples of a fork assembly having a steer limiting mechanism, are described below and illustrated in the associated drawings. Unless otherwise specified, a fork assembly in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

The terms “inboard,” “outboard,” “forward,” “rearward,” and the like are intended to be understood in the context of a host vehicle on which systems described herein may be mounted or otherwise attached. For example, “outboard” may indicate a relative position that is laterally farther from the centerline of the vehicle, or a direction that is away from the vehicle centerline. Conversely, “inboard” may indicate a direction toward the centerline, or a relative position that is closer to the centerline. Similarly, “forward” means toward the front portion of the vehicle, and “rearward” means toward the rear of the vehicle. In the absence of a host vehicle, the same directional terms may be used as if the vehicle were present. For example, even when viewed in isolation, a device may have a “forward” edge, based on the fact that the device would be installed with the edge in question facing in the direction of the front portion of the host vehicle.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a fork assembly for a bicycle in accordance with the present teachings may include an external steerer fork assembly (AKA a bayonet-style fork assembly) configured to be rotatably coupled to a head tube of a bicycle frame. The fork assembly includes a fork body and fork blade(s), the fork body being generally C-shaped and configured to be disposed external to the head tube of the bicycle. A tension rod is coupled to the fork body and configured to extend through an at least partially hollow interior of the head tube. The tension rod extends through the hollow interior of the head tube parallel to the axis of rotation of the fork assembly and offset from the axis of rotation. As a result, the tension rod is configured to move (i.e., revolve) about the axis of rotation, when the fork assembly is rotated relative to the head tube of the bicycle frame. In some examples, the offset between the rod and the axis remains constant as the rod revolves or orbits around the axis of rotation, such that the rod traces an imaginary cylindrical surface (or a portion of one) centered on the axis of the head tube.

In some examples, the fork assembly includes a C-shaped fork body coupled to one or more fork blades. The upper portion of the fork body may comprise any suitable structure(s) (e.g., bearing surfaces) configured to be coupled to and support a handlebar stem of the bicycle. The upper bearing surface of the fork body is configured to be disposed at least partially above an upper end of the head tube, when the fork assembly is coupled to the bicycle frame. In some examples, the fork body includes one or more cable apertures configured to receive and/or guide cable(s) into a hollow interior of the head tube of the bicycle and/or a hollow interior of the fork body to be routed to the front or rear wheel of the bicycle (e.g., to control a disk brake system).

A front member (AKA shell, covering, front cover, front portion) of the fork body extends downward from the upper portion of the fork body to the one or more fork blades. The front member is configured to be generally vertical when installed, and disposed forward of a front surface of the head tube, generally (e.g., partially) covering the front surface of the head tube. The front member is configured to provide an aerodynamic structural support, transmitting torque applied to the fork body by the handlebar stem (e.g., due to a rider turning the handlebars) to the one or more fork blades. Although referred to as a “front” member herein, the front member may include one or more portions extending around lateral sides of the front tube and/or behind the front tube. In some examples, this structure is referred to as a connecting member.

In some examples, the fork body includes a lower bearing surface extending rearward from a bottom end of the front member. The lower bearing surface may be configured to extend at least partially beneath and/or into a lower end of the head tube, when the fork assembly is coupled to the bicycle frame. The one or more fork blades extend downward from the front member and the lower bearing surface. The one or more fork blades are configured to be coupled to a front wheel of the bicycle, e.g., at a hub of the wheel.

In some examples, the fork body is formed as a single piece, is unitary, monolithic, and/or integral. In other words, the fork body including the front member may form a continuous, unitary, or integral piece with the one or more fork blades. In some examples, the front member and one or more of the fork blades are at least partially hollow to facilitate internal routing of cables, wires, lines, and/or hoses (e.g., hydraulic brake hoses) from the handlebars to the front wheel. The fork assembly may comprise any suitable material configured to facilitate efficiently transmitting forces from the handlebars of the bicycle to the front wheel connected to the one or more fork blades. For example, the fork body may comprise aluminum, steel, carbon fiber, titanium, and/or any other suitable material(s).

In some examples, fork assemblies of the present disclosure include a preload insert secured to the upper portion of the fork body. The preload insert is configured to preload upper headset bearings disposed at an upper end of the head tube of the bicycle frame. Preloading the upper headset bearings facilitates improved rotation of the fork assembly relative to the head tube of the bicycle frame and may prevent the bearings from skidding. The preload insert may be secured to the upper portion of the fork body by screws, clips, clamps, and/or any other suitable mechanisms or fasteners. In some examples, the upper portion of the fork body has an aperture that is configured to receive the preload insert and that is configured to be tightened around the preload insert (e.g., by tightening a screw). In other words, the fork body itself may be configured as a pinch clamp that securely holds the preload insert.

The preload insert may be coupled to an upper end portion of the tension rod by any suitable mechanism. For example, the preload insert may include a bore that is configured to receive and securely hold the upper end portion of the tension rod. The tension rod is configured to extend downward through the head tube from the preload insert to the lower bearing surface of the fork body disposed beneath the head tube. The tension rod may be coupled to the lower bearing surface of the fork body by any suitable mechanism. For example, the tension rod may have a threaded end that is secured to a threaded aperture in the lower bearing surface of the fork body.

In some examples, fork assemblies of the present disclosure include one or more steer-limiting mechanisms configured to limit rotation (e.g., an angular span) of the fork assembly relative to the head tube of the bicycle frame. In other words, the fork assembly may include one or more mechanisms that prevent the fork assembly from rotating beyond a predetermined maximum rotation angle in each direction (e.g., 30, 45, or 90 degrees to the right or to the left). Limiting the degree of rotation of the fork assembly may prevent oversteering by a rider of the bicycle and/or may prevent damage to the bicycle in the event of a crash or during transport.

In some examples, the steer-limiting mechanism includes an arcuate aperture formed in a transverse wall of the head tube. One or more such transverse walls may be disposed adjacent a lower or bottom end of the head tube, an upper end of the head tube, and/or in any other suitable position with respect to the head tube. In such examples, the tension rod extends through the arcuate aperture. When the fork assembly is rotated relative to the head tube, the tension rod revolves about the axis of rotation as limited by the arcuate aperture. The arcuate aperture has a predetermined size and shape configured to limit the movement of the tension rod, and therefore to limit rotation of the fork assembly. In other words, the fork assembly is able to rotate in either direction (e.g., clockwise or counterclockwise) until the tension rod contacts or abuts an edge of the arcuate aperture which arrests the tension rod and prevents the fork assembly from rotating further in that direction.

### Examples, Components, and Alternatives

The following sections describe selected aspects of illustrative fork assemblies as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Fork Assembly

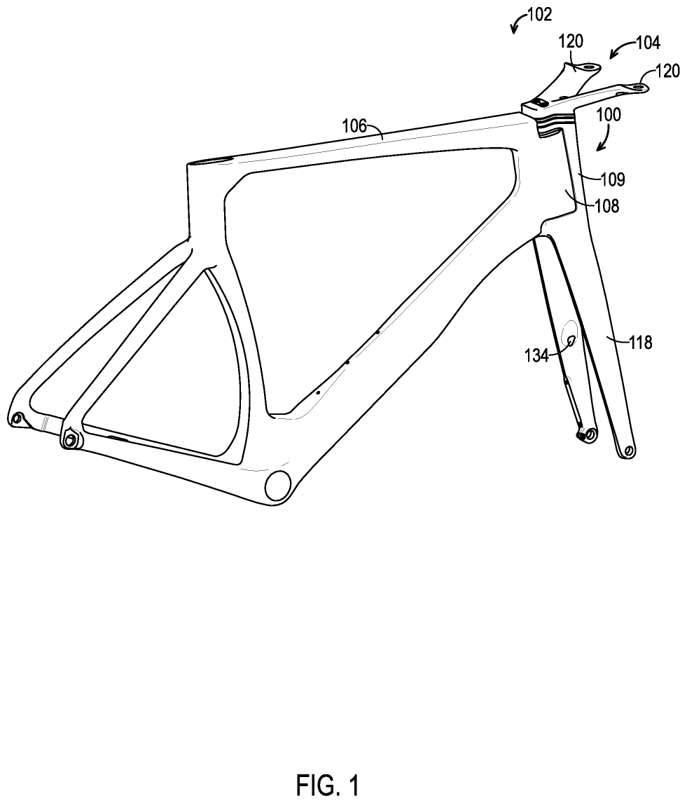

As shown in FIGS. 1-10, this section describes an illustrative fork assembly 100 for a bicycle 102. Fork assembly 100 is an example of the fork assemblies, described above in the overview.

FIG. 1 depicts an isometric view of bicycle 102 including fork assembly 100, handlebar stem 104, and bicycle frame 106. Bicycle frame 106 may comprise any suitable frame configured to be coupled to fork assembly 100. In some examples, bicycle frame 106 includes one or more (e.g., hollow) tubes (e.g., a head tube 108) comprising an alloy material, a composite material, and/or any other suitable material. For example, bicycle frame 106 may comprise steel, aluminum, carbon fiber, titanium, and/or the like. Bicycle frame 106 may include a portion referred to as the front triangle of the frame.

Fork assembly 100 is coupled to head tube 108 of bicycle frame 106, such that fork assembly 100 is rotatable relative to head tube 108 and frame 106. In general, fork assembly 100 is an “external steerer” fork assembly (AKA a “bayonet-style” or “bayonet” fork assembly) having pivot bearings at the top and bottom of head tube 108. At least a portion of fork assembly 100 is disposed inside of head tube 108 and at least a portion of fork assembly 100 is disposed external to head tube 108, when fork assembly 100 is coupled to frame 106. For example, fork assembly 100 includes a C-shaped fork body 109 that is disposed external to head tube 108 and fork assembly 100 includes a tension rod 114 that extends through head tube 108.

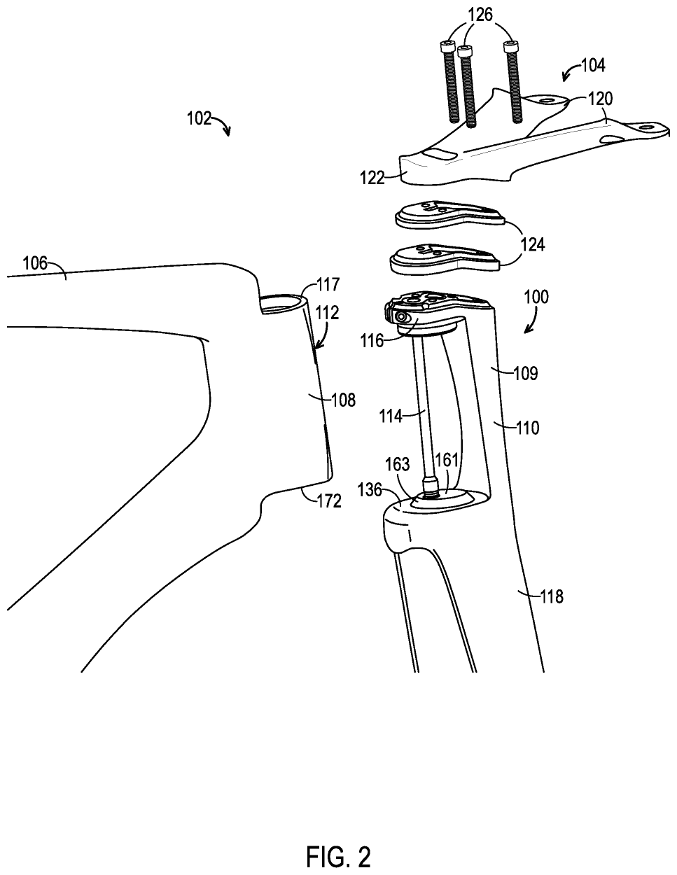

As shown in the exploded view of FIG. 2, fork body 109 includes an upper portion 116 (also referred to herein as the upper bearing surface or fork top) and a lower portion 136 (AKA the lower bearing surface or fork bottom), the body being connected to one or more fork blades 118 by a front member 110 (AKA front portion, front shell, front cover). Upper portion 116 of fork body 109 may comprise any suitable structure(s) configured to be coupled to and support handlebar stem 104. Upper portion 116 is configured to interface with an upper end 117 of head tube 108 when the fork assembly is coupled to the bicycle frame. In some examples, upper portion 116, front member 110, and lower portion 136 of fork body 109 are monolithic and formed as a single piece. In some examples, upper portion 116 is configured to be fastened to an upper end of front member 110 using a suitable fastener (e.g., bolts, screws, etc.). In other words, upper portion 116 may be a separate piece from front member 116 and lower surface 136 and may be configured to be fastened to front member 116 to form fork body 109.

Front member 110 (AKA connecting member 110, in that it connects the fork top to the fork bottom) of fork body 109 is connected to fork top 116 and extends downward from the fork top to the fork bottom and one or more fork blades 118. Front member 110 is configured to be disposed in front of a front surface 112 of head tube 108. In some examples, front member 110 may include one or more portions extending around lateral sides of the front tube and/or behind the front tube. Front member 110 may include any suitable structure disposed external to the head tube and configured to transmit torque applied by handlebar stem 104 (e.g., due to a rider turning the handlebars) to one or more fork blades 118. In some examples, lower bearing surface 136 extends rearward from a bottom end of front member 110. Lower bearing surface 136 may be configured to interface with and extend at least partially beneath a lower end 172 of head tube 108. Fork blades 118 are configured to be coupled to a front wheel of the bicycle.

In some examples, fork body 109 and fork blades 118 are integral. In some examples, front member 110 and one or more of fork blades 118 are at least partially hollow to facilitate internal routing of one or more cables, wires, lines, and/or hoses from the handlebars to the front wheel. Fork body 109 may comprise any suitable material configured to facilitate efficiently transmitting forces from the handlebars of the bicycle to the front wheel connected to the one or more fork blades. For example, fork body 109 may comprise aluminum, steel, carbon fiber, titanium, and/or any other suitable material(s). In some examples, front member 110, upper bearing surface 116, lower bearing surface 136, and fork blades 118 comprise a same material as bicycle frame 106 (e.g., carbon fiber, aluminum, steel, etc.). In some examples, bicycle frame 106 comprises aluminum and one or more portions of fork assembly 100 comprise a composite material (e.g., carbon fiber).

Handlebar stem 104 may comprise any suitable structure configured to support handlebars of bicycle 102. In the example of FIGS. 1 and 2, handlebar stem 104 comprises a V-shaped stem having a pair of stem arms 120 extending outward from a base portion 122. Stem arms 120 are configured to be coupled to and support a handlebar set of bicycle 102. For example, stem arms 120 may be coupled to a base bar of the handlebar set. Base portion 122 of handlebar stem 104 is configured to be coupled to upper bearing surface116 of fork assembly 100 in any suitable manner configured to facilitate transmitting torque from the handlebars to fork assembly 100. For example, as shown in FIG. 2, one or more screws 126 may be utilized to fasten base portion 122 of handlebar stem 104 to the fork top.

In some examples, as shown in FIG. 2, one or more stem spacers 124 are disposed between base portion 122 of handlebar stem 104 and upper portion 116 of the fork when base portion 122 is fastened to the fork top. Stem spacers 124 are configured to provide a space between base portion 122 and the fork assembly, and therefore to raise the height of the handlebar set coupled to handlebar stem 104. Any suitable number and size of stem spacers 124 (e.g., 2.5 mm, 5 mm, 7.5 mm, etc.) may be disposed between base portion 122 and the fork top, depending on the rider's desired height for the handlebars of bicycle 102. In some examples, no stem spacers are utilized and base portion 122 of handlebar stem 104 is coupled directly to upper portion 116. In some examples in which stem spacers 124 are present, screws 126 extend through stem spacers 124 to fasten base portion 122 of handlebar stem 104 to upper portion 116.

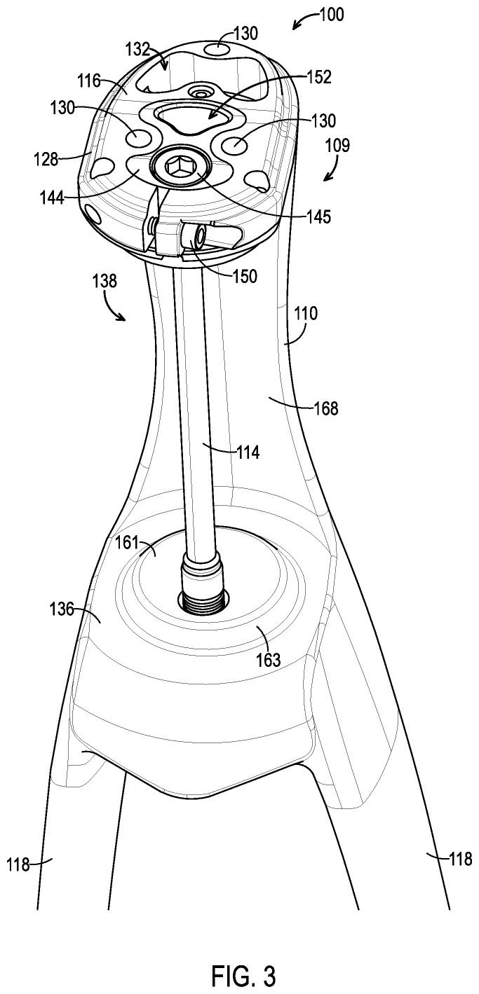

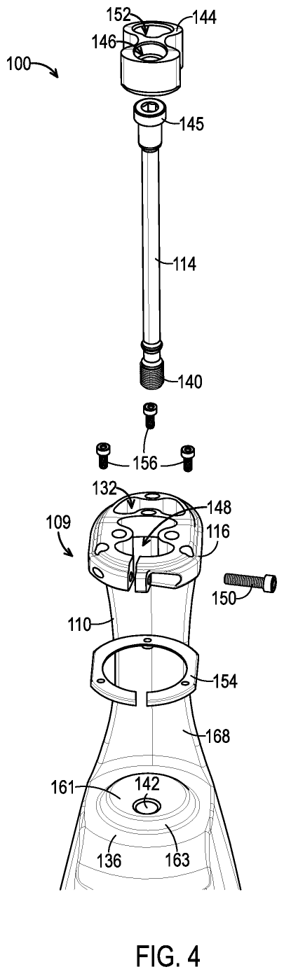

FIG. 3 depicts an isometric view of fork assembly 100 and FIG. 4 depicts an exploded view of fork assembly 100. As shown in FIGS. 3 and 4, fork assembly 100 includes fork body 109 having upper portion 116 configured to be coupled to base portion 122 of handlebar stem 104. In some examples, upper portion 116 of the fork assembly includes one or more recesses, projections, and/or other suitable features configured to mate with complementary features of base portion 122 and/or stem spacers 124. In the example of FIGS. 3 and 4, upper portion 116 includes a recessed perimeter 128 configured to mate with and align base portion 122 and/or stem spacers 124 relative to the fork top. Upper portion 116 includes screw apertures 130 (e.g., threaded holes) configured to receive screws 126 to fasten base portion 122 to upper portion 116.

Fork top 116 includes one or more cable or hose apertures 132 configured to receive one or more cables, wires, lines, and/or hoses from handlebar stem 104 (e.g., front brake cables or hydraulic brake hoses). In some examples, front member 110 and fork blades 118 of fork assembly 100 each have a hollow interior and first hose aperture 132 is in communication with the hollow interior of front member 110 and fork blades 118. First hose aperture 132 and the hollow interior of front member 110 and fork blades 118 facilitate internal routing of front brake hoses from handlebar set 104 to the front wheel brake system of the bicycle (e.g., disk brake system). For example, the one or more hoses may extend from handlebar stem 104 through cable aperture 132 in fork top 116 and into front member 110 and fork blades 118 to be routed to the front wheel brake of bicycle 102. In some examples, as shown in FIG. 1, one or more of fork blades 118 includes a fork blade aperture 134 configured to allow the cables or hoses to exit the hollow interior of fork blade 118 to control a (e.g., hydraulic) disk brake or any other suitable brake of the bicycle.

Fork body 109 includes front member 110 extending from fork top 116 to lower surface 136 and fork blades 118. Front member 110 is disposed on a front side of the fork body and configured to abut a front surface 112 of head tube 108. As shown in FIG. 3, front member 110 has a rear surface 168 that is complementary with respect to front surface 112 of head tube 108. For example, as shown in FIG. 3, rear surface 168 of front member 110 is concave and front surface 112 of head tube 108 is convex. This facilitates smooth rotation of front member 110 and fork body 109 relative to head tube 108.

Lower bearing surface 136 of fork body 109 is configured to interface with and be disposed at least partially below head tube 108 when fork assembly 100 is coupled to the head tube. In some examples, lower bearing surface 136 of fork assembly is configured to contact and preload a lower bearing race disposed at lower end 172 of head tube 108. For example, as shown in FIG. 3, lower bearing surface 136 includes a raised portion 161 having a slanted edge 163 configured to contact and preload a lower bearing race.

Fork assembly 109 includes fork blades 118 extending downward from lower surface 136 and front member 110 of fork body 109. Fork blades 118 are configured to be coupled to a front wheel of bicycle 102 in any suitable manner. In some examples, as shown in FIG. 3, fork assembly 100 includes a pair of fork blades. However, in some examples, fork assembly 100 may include only one fork blade 118.

In some examples, upper portion 116, front member 110, lower bearing surface 136, and fork blades 118 of fork assembly 100 are integral or unitary. Fork assembly 100 is configured to connect the handlebars of the bicycle to the front wheel of the bicycle to facilitate steering of the bicycle. The fork assembly may comprise any suitable material(s) configured to provide sufficient rigidity and stiffness to facilitate transmitting torque applied to the handlebars (e.g., by a rider turning the handlebars) to the front wheel to steer the bicycle.

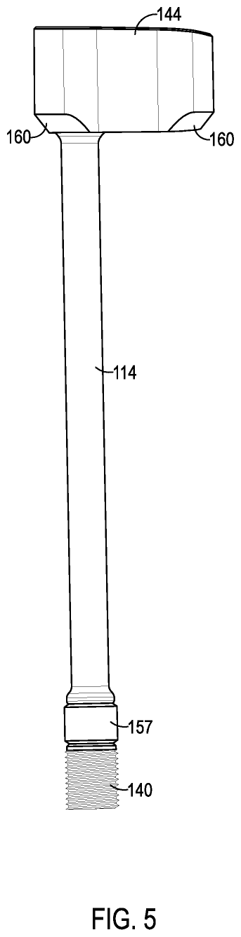

Fork assembly 100 includes a tension rod 114 (AKA preload rod) that extends from upper portion 116 to lower bearing surface 136 of fork assembly 100. Tension rod 114 is disposed rearward of front member 110 and is disposed within a hollow or space 138 extending between upper portion 116 and lower surface 136. Tension rod 114 is positioned in the fork assembly so as to be offset from the central axis of the head tube when installed. As shown in FIGS. 4 and 5, tension rod 114 includes a threaded end 140 configured to be coupled to a complementary threaded aperture 142 disposed in lower surface 136 of fork assembly 100. In some examples, tension rod 114 is cylindrical. In some examples, tension rod 114 is non-cylindrical (e.g., the tension rod may have a rectangular or square cross-section). A head or upper portion 145 of tension rod 114 is configured to be coupled to a preload insert 144 of fork assembly 100.

Preload insert 144 of fork assembly 100 is configured to preload headset bearings of head tube 108 to facilitate rotation of fork assembly 100 relative to head tube 108. Preload insert 144 is configured to be secured to upper portion 116 and configured to be coupled to head portion 145 of tension rod 114. Preload insert 144 may be secured to upper portion 116 by screws, mating surfaces, clips, clamps, and/or by any other suitable mechanism. In the example of FIGS. 3-4, preload insert 144 is disposed within an aperture 148 in upper portion 116 and upper portion 116 is configured such that aperture 148 may be tightened around preload insert 144. Aperture 148 may have a size and shape that is configured to accommodate and receive preload insert 144. For example, aperture 148 may have a substantially similar planform to a planform of preload insert 144. In some examples, aperture 148 may have slightly larger dimensions than preload insert 144 to facilitate inserting preload insert 144 within aperture 148. After preload insert 144 is inserted within aperture 148, aperture 148 is configured to be tightened around preload insert 144 by tightening screw 150. In this manner, upper portion 116 is configured as a pinch clamp that is configured to tighten aperture 148 around preload insert 144 to securely hold preload insert 144 within upper portion 116.

Preload insert 144 is configured to be coupled to head portion 145 of tension rod 114 in any suitable manner. For example, preload insert 144 may include a bore 146 configured to receive head portion 145 of tension rod 114. In some examples, bore 146 includes a shoulder and/or any other suitable feature configured to prevent head portion 145 from exiting bore 146. In such examples, tension rod 114 may be configured to be inserted into bore 146 from a top side of the bore. Threaded end 140 and a main shaft of tension rod 114 may pass through an entirety of bore 146 to be coupled to lower surface 136, but head portion 145 may be prevented from passing through the entirety of bore 146 by the shoulder or other feature in the bore.

In some examples, as shown in FIGS. 3 and 4, preload insert 144 includes a second cable or hose aperture 152 (AKA hose opening) configured to receive one or more cables, wires, lines, and/or hoses (e.g., rear brake cables or hydraulic break hoses) from handlebar set 104 and the handlebars. Hose aperture 152 is in communication with hollow or space 138 extending between upper portion 116 and lower surface 136, such that the hoses may pass through hose aperture 152 into space 138. When fork assembly 100 is coupled to head tube 108, space 138 is disposed inside of a hollow interior 162 of head tube 108 and hose aperture 152 facilitates receiving the hoses into the hollow interior of bicycle frame 106. In this manner, hose aperture 152 facilitates internal routing of the hoses from the handlebars to a rear wheel braking system (e.g., rear disk braking system) of bicycle 102.

In some examples, as shown in FIG. 4, fork assembly 100 includes a bearing gap spacer 154 configured to be disposed between a bottom surface of upper portion 116 and an upper surface of head tube 108, when fork assembly 100 is rotatably coupled to head tube 108. Bearing gap spacer 154 may have any suitable size configured to provide a space and/or fill a space between upper portion 116 and the upper surface of head tube 108, e.g., 2.5 mm, 5 mm, etc. Bearing gap spacer 154 may be fastened to upper portion 116 by screws 156 and/or by any other suitable fasteners.

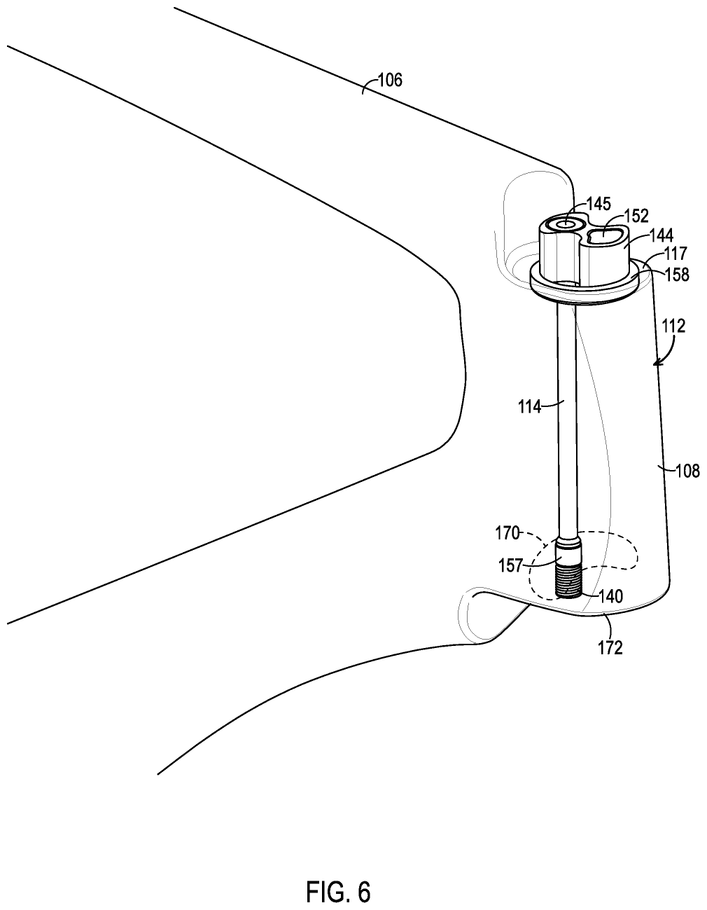

FIG. 5 depicts tension rod 114 inserted in and coupled to preload insert 144. As shown in FIG. 5, tension rod 114 may include a tension rod bumper 157 disposed around a lower portion of a shaft of tension rod 114. Tension rod bumper 157 provides a durable surface for contacting portions of head tube 108, as described further below. In some examples, as shown in FIGS. 5 and 6, preload insert 144 includes one or more recesses, projections, tapered or beveled edges, and/or other suitable features configured to mate with an upper bearing race 158 disposed on a top side of head tube 108. As shown in FIG. 5, preload insert 144 includes a tapered or beveled bottom edge 160 configured to contact upper bearing race 158 and configured to apply a downward force on upper bearing race 158 to preload the bearings. Preload insert 144 may be sized such that the bottom edge of preload insert 144 extends downward below a bottom surface of upper portion 116 and bearing gap spacer 154. This facilitates preload insert 144 contacting and preloading upper bearing race 158 of head tube 108.

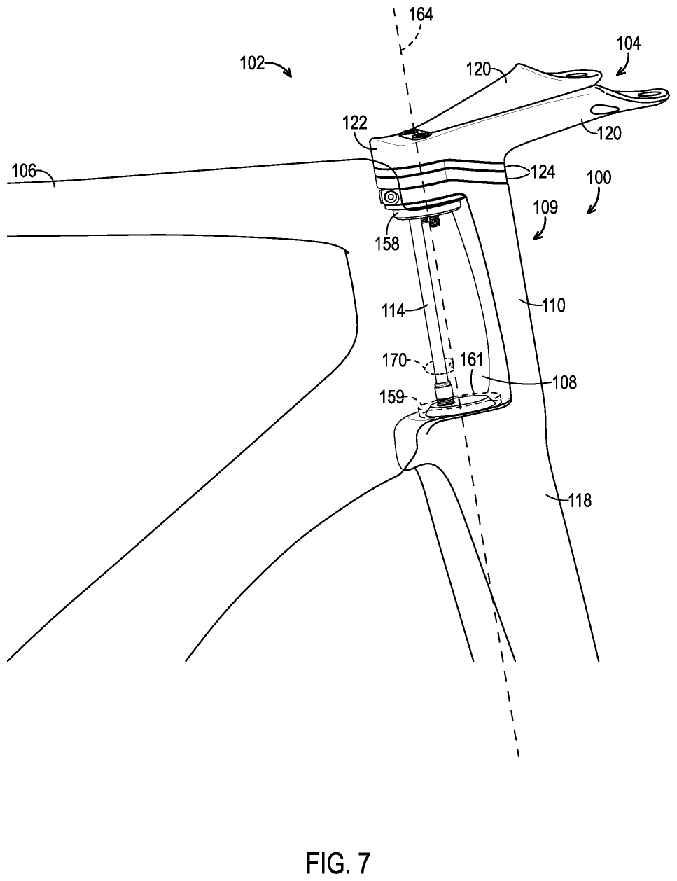

FIG. 6 depicts preload insert 144 positioned at a top portion of head tube 108 and disposed on upper bearing race 158. Tension rod 114 is coupled to preload insert 144 and extends through upper bearing race 158 and through a hollow interior 162 of head tube 108. As shown in FIG. 7, tension rod 114 is coupled at a bottom end to lower surface 136 of assembly 100 by the threaded connection between threaded end 140 of the tension rod and threaded aperture 142 of the lower surface. Tightening the threaded connection between tension rod 114 and threaded aperture 142 generates a downward force on preload insert 144 that facilitates preloading the upper bearing race 158 of head tube 108. The preload of upper bearing race 158 facilitates improved rotation of fork assembly 100 relative to head tube 108 and may prevent the bearings from skidding.

Head tube 108 and fork assembly 100 may have any suitable headset components configured to facilitate rotation of fork assembly 100 relative to head tube 108. For example, as described above, preload insert 144 may preload upper bearing race 158 of head tube 108 to facilitate rotation of fork assembly 100 relative to head tube 108. In some examples, lower surface 136 of fork assembly is configured to contact and preload a lower bearing race disposed at a bottom portion of head tube 108. For example, raised portion 161 having slanted edge 163 of lower surface 136 may be configured to contact and preload the lower bearing race. The lower bearing race may be substantially similar to upper bearing race 158.

FIG. 7 depicts fork assembly 100 coupled to head tube 108 of bicycle frame 106 and disposed in a neutral position. As shown in FIG. 7, fork assembly 100 is configured to rotate relative head tube 108 about an axis of rotation 164 in response to a rotation of a handlebar set coupled to handlebar stem 104. Axis 164 may coincide with the central axis of the head tube. For example, a rider of bicycle 102 may turn the handlebars coupled to handlebar stem 104 to rotate fork assembly 100 relative to head tube 108. In other words, fork assembly 100 is rotatably coupled to head tube 108 by a pair of pivotable joints including upper and lower bearing races 158 and 159 and rotates relative to head tube 108 on bearing races 158, 159.

As shown in FIG. 7, axis of rotation 164 is disposed between tension rod 114 and front member 110 of fork assembly 100. In other words, tension rod 114 and front member 110 are offset from axis 164 on opposing sides of the axis of rotation. Tension rod 114 extends through hollow interior 162 of head tube 108 offset from axis 164 and generally parallel to axis 164. As shown in FIG. 7, tension rod 114 is offset from axis of rotation 164, such that tension rod is disposed rearward of axis of rotation 164 during operation. As a result, tension rod 114 is configured to orbit and/or revolve about axis of rotation 164 within hollow interior 162 of head tube 108, when fork assembly 100 is rotated relative to head tube 108. Tension rod 114 may be offset from axis of rotation 164 by any suitable distance.

Fork body 109 is configured to rotate and/or pivot about axis of rotation 164 on upper and lower bearing races 158, 159. Tension rod 114 and fork body 109 are connected at upper portion 116 and lower bearing surface 136, such that tension rod 114 and fork body 109 are configured to move together or in unison as the fork body pivots about axis of rotation 164.

Head tube 108 of bicycle frame 106 and/or fork assembly 100 may have one or more steer-limiting mechanisms configured to limit the angular span over which fork assembly 100 is able to rotate relative to head tube 108. For example, as shown in FIGS. 6-10, head tube 108 of bicycle frame 106 includes a transverse wall 176 (or floor) disposed adjacent lower end 172 of hollow interior 162 of head tube 108 and having an arcuate aperture 170 (AKA steer limiting aperture). In some examples, transverse wall 176 is disposed adjacent upper end 117 of head tube 108 and/or disposed in any other suitable position with respect to head tube 108. The aperture in the transverse wall may have an arcuate, crescent, semi-circular, and/or curvilinear shape. Tension rod 114 extends through arcuate aperture 170 between preload insert 144 and lower surface 136 of fork body 109. Arcuate aperture 170 is configured to limit the angular span through which tension rod 114 is able to orbit or revolve about axis of rotation 164. For example, when fork assembly 100 is rotated relative to head tube 108 in a clockwise direction, tension rod 114 orbits about axis of rotation 164 in the clockwise direction within arcuate aperture 170. When tension rod 114 contacts the edge of arcuate aperture 170, tension rod 114 is prevented from moving further in the clockwise direction by the edge of the arcuate aperture. This prevents fork body 109 from rotating further in the clockwise direction relative to head tube 108. In some examples, tension rod bumper 157 is configured to contact the edge of the arcuate aperture to prevent damaging tension rod 114.

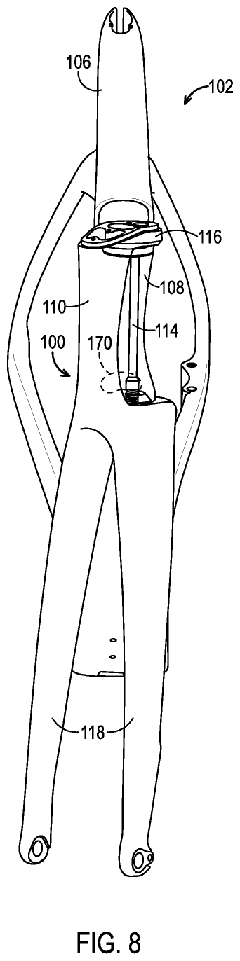

FIG. 8 depicts a front view of bicycle 102 having fork assembly 100 rotated to a maximum rotation angle allowed by arcuate aperture 170. As shown in FIG. 8, fork body 109 and tension rod 114 are moved clockwise about axis of rotation 164. This may occur when a rider turns handlebars to the right, causing tension rod 114 and fork body 109 to move in unison in the clockwise direction about axis of rotation 164. In FIG. 8, tension rod 114 is contacting the edge (a left-side edge) of arcuate aperture 170, and the edge of arcuate aperture 170 prevents tension rod 114 from moving further in the clockwise direction. This prevents fork assembly 100 as a whole from rotating further in the clockwise direction (i.e., to the right from the rider's perspective). Similarly, a rider of bicycle 102 may turn the handlebars to the left, causing tension rod 114 and fork body 109 to move counterclockwise. Fork assembly 100 may be rotated to the left until tension rod 114 contacts a right-side edge of arcuate aperture 170. When tension rod 114 contacts the right-side edge of arcuate aperture 170, fork assembly 100 is prevented from rotating further in the counterclockwise direction around axis of rotation 164 (i.e., to the left from the riders perspective).

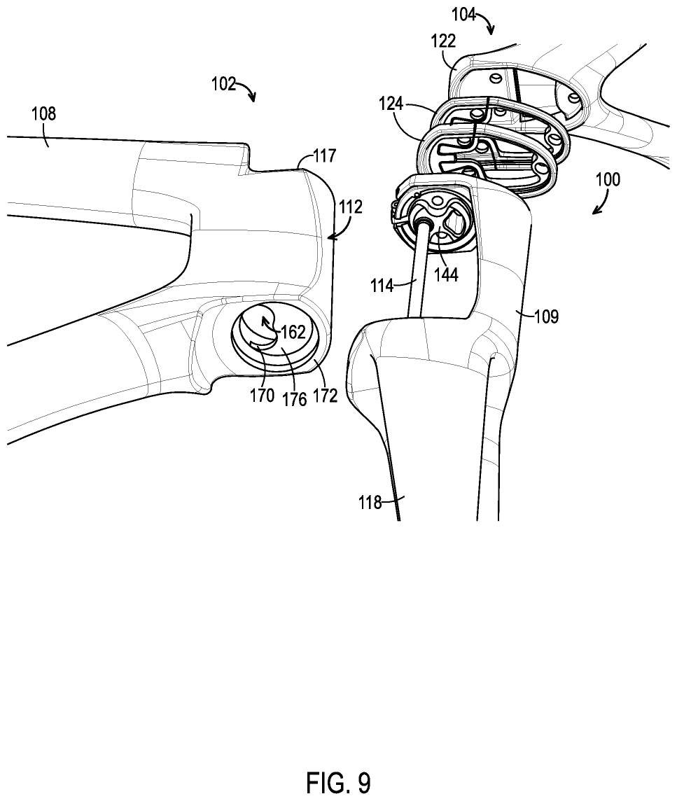

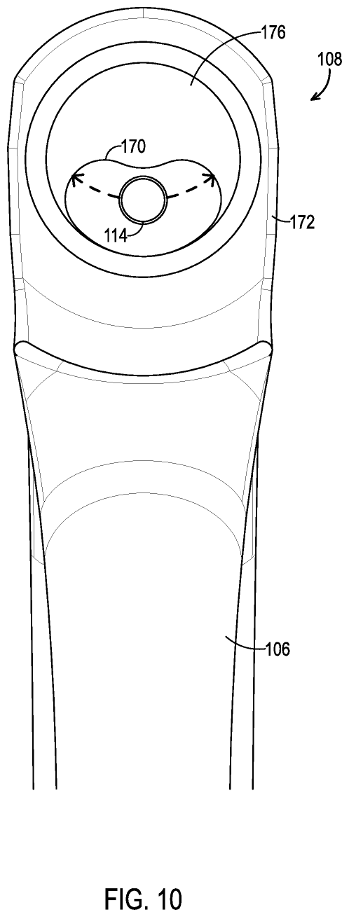

FIG. 9 depicts an exploded view of bicycle frame 106, fork assembly 100, and handlebar stem 104. FIG. 10 depicts a bottom view of bicycle frame 106 having tension rod 114 inserted within head tube 108. As shown in FIGS. 9 and 10, arcuate aperture 170 is disposed at a bottom end 174 of head tube 108. In some examples, wall 176 in hollow interior 162 of head tube 108 may be disposed near a bottom of the head tube, defining a bottom extent of hollow interior 162. However, the wall may have any suitable position and any suitable number of walls may be utilized. In some examples, wall 176 is disposed near a middle or top of the head tube.

Arcuate aperture 170 may have any suitable shape, planform, and/or size depending on the desired maximum angular span of rotation of fork assembly 100 relative to head tube 108. For example, arcuate aperture 170 may be sized and shaped to limit the orbital motion of tension rod 114, and therefore the rotation of fork assembly 100, to 30 degrees or less in either direction, 45 degrees or less in either direction, 90 degrees or less in either direction, and/or any other suitable number of degrees in either direction. The limits on rotation of the fork assembly may be symmetrical (i.e., the same number of degrees in each direction) or asymmetrical.

As described above, arcuate aperture 170 formed in a bottom wall 176 of head tube 108 and tension rod 114 of fork assembly 100 collectively form a steering stop or a steer-limiting mechanism of bicycle 102. The steer-limiting mechanism is configured to limit the maximum angle of rotation that fork assembly 100 is able to rotate relative to bicycle frame 106 in either direction (i.e., clockwise or counterclockwise). Limiting the maximum angle of rotation of fork assembly 100 may facilitate preventing over steering by a rider that may result in the rider crashing the bicycle. In some examples, limiting the maximum angle of rotation of fork assembly 100 may facilitate preventing damage of fork assembly 100 and/or bicycle frame 106 in the event of a crash or during transport of the bicycle.

### B. Illustrative Combinations and Additional Examples

This section describes additional aspects and features of a fork assembly having a steer-limiting mechanism, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A bicycle comprising:
a main frame including a head tube having a hollow interior;
a fork assembly rotatably coupled to the head tube of the main frame, such that the fork assembly is configured to rotate relative to the head tube about an axis of rotation, wherein the fork assembly includes:
   a fork body disposed external to the head tube of the main frame; and
   a tension rod coupled to the fork body and extending through the head tube of the main frame;
   wherein the tension rod is offset from the axis of rotation, such that the tension rod is configured to orbit about the axis of rotation, when the fork assembly is rotated relative to the main frame; and
   wherein the tension rod extends through an aperture in a bottom wall of the head tube and the aperture is configured to limit the angular range of motion of the tension rod and thereby to limit rotation of the fork assembly about the axis of rotation.

A1. The bicycle of paragraph A0, further comprising a preload insert secured to an upper portion of the fork body, wherein the preload insert is configured to preload headset bearings disposed at an upper end of the head tube.

A2. The bicycle of paragraph A1, wherein an upper end of the tensioning rod is coupled to the preload insert and a lower end of the tensioning rod is coupled to a lower surface of the fork body disposed beneath the head tube.

A3. The bicycle of any one of paragraphs A0-A2, wherein the aperture in the bottom wall of the head tube is an arcuate aperture.

A4. The bicycle of any one of paragraphs A0-A3, wherein the aperture is configured to limit the rotation of the fork assembly to less than or equal to 90 degrees in the clockwise direction and less than or equal to 90 degrees in the counterclockwise direction around the axis of rotation.

A5. The bicycle of any one of paragraphs A0-A4, wherein the fork body includes an upper portion configured to be coupled to a handlebar stem of the bicycle.

A6. The bicycle of any one of paragraphs A0-A5, wherein the fork assembly further includes one or more fork blades extending downward from a lower end of the fork body.

A7. The bicycle of paragraph A6, wherein the fork assembly is formed as a single piece.

A8. The bicycle of any one of paragraphs A0-A7, wherein the fork body includes one or more first cable openings configured to receive one or more cables into an at least partially hollow interior of the fork body.

A9. The bicycle of any one of paragraphs A0-A8, wherein the fork body includes one or more second cable openings configured to receive one or more cables into the hollow interior of the head tube of the main frame.

B0. A fork assembly for a bicycle, the fork assembly comprising:
a fork body configured to be rotatably coupled to a head tube of a bicycle frame, such that the fork body rotates about an axis of rotation relative to the head tube, wherein the fork body is configured to be disposed external to the head tube; and
a tension rod coupled to the fork body and configured to extend through a hollow interior of the head tube;
wherein the tension rod is configured to be offset from the axis of rotation, such that the tension rod is configured to revolve about the axis of rotation, when the fork body is rotated relative to the head tube; and
wherein the tension rod is configured to contact portions of the head tube to limit the angular range of motion of the tension rod and thus to limit the angular range of rotation of the fork body about the axis of rotation.

B1. The fork assembly of paragraph B0, further comprising a preload insert secured to a upper portion of the fork body, wherein the preload insert is configured to preload headset bearings disposed at an upper end of the head tube.

B2. The fork assembly of paragraph B1, wherein an upper end of the tensioning rod is coupled to the preload insert and a lower end of the tensioning rod is coupled to a lower surface of the fork body configured to be disposed beneath the head tube.

B3. The fork assembly of any one of paragraphs B0-B2, wherein the fork body includes one or more first cable openings configured to receive one or more cables into an at least partially hollow interior of the fork body.

B4. The fork assembly of any one of paragraphs B0-B3, wherein the fork body includes one or more second cable openings configured to receive one or more cables into the hollow interior of the head tube of the main frame.

B5. The fork assembly of any one of paragraphs B0-B4, wherein the fork body includes an upper portion configured to be coupled to a handlebar stem of the bicycle.

B6. The fork assembly of paragraph B5, wherein the fork assembly further comprises one or more fork blades extending downward from the fork body.

B7. The fork assembly of paragraph B6 wherein the fork assembly is formed as a single piece.

B8. The fork assembly of any one of paragraphs B0-B7, wherein the tension rod is configured to extend through an aperture in a bottom wall of the head tube and the aperture is configured to limit the range of rotation of the tension rod.

C0. A bicycle comprising:
a frame including a head tube;
a fork assembly rotatably coupled to the head tube and configured to rotate relative to the head tube about an axis of rotation, wherein the fork assembly includes:
   a fork body having an upper portion interfaced with an upper end of the head tube, a lower bearing surface interfaced with a lower end of the head tube, and a front member disposed forward of a front surface of the head tube; and
   a tension rod extending from the upper portion to the lower bearing surface through an aperture of an inner wall of the head tube at a position offset from the axis of rotation, wherein the tension rod is configured to move with rotation of the fork body;
   wherein the inner wall is oriented transverse to the axis of rotation and the aperture is configured to limit a range of motion of the tension rod.

C1. The bicycle of paragraph C0, further comprising a preload insert secured to the upper portion, wherein the preload insert is configured to preload headset bearings disposed at the upper end of the head tube.

C2. The bicycle of paragraph C1, wherein an upper end of the tensioning rod is coupled to the preload insert and a lower end of the tension rod is coupled to the lower bearing surface.

C3. The bicycle of any one of paragraphs C0-C2, wherein the upper portion is configured to be coupled to a handlebar stem of the bicycle.

C4. The bicycle of any one of paragraphs C0-C3, further comprising one or more fork blades extending downward from a lower end of the fork body.

C5. The bicycle of paragraph C4, wherein the fork body is configured to transmit torque from the upper portion to the fork blades to steer the bicycle.

C6. The bicycle of any one of paragraphs C0-C5, wherein the fork assembly is formed as a single piece.

C6.1 The bicycle of any one of paragraphs C0-C5, wherein the upper portion of the fork body is fastened to an upper end of the front member.

C7. The bicycle of any one of paragraphs C0-C6.1, wherein the aperture is an arcuate aperture.

C8. The bicycle of any one of paragraphs C0-C7, wherein the upper portion includes a first opening configured to receive one or more first cables, wires, lines, and/or hoses into an interior of the fork body.

C9. The bicycle of any one of paragraphs C0-C8, wherein the upper portion includes a second opening configured to receive one or more second cables, wires, lines, and/or hoses into the head tube.

C10. The bicycle of any one of paragraphs C0-C9, wherein the tension rod is cylindrical.

C11. The bicycle of any one of paragraphs C0-C9, wherein the tension rod is non-cylindrical.

C12. The bicycle of any one of paragraphs C0-C11, wherein the inner wall is adjacent a lower end of the head tube.

C13. The bicycle of any one of paragraphs C0-C12, wherein the inner wall is adjacent an upper end of the head tube.

D0. A fork assembly for a bicycle, the fork assembly comprising:
a fork body configured to be rotatably coupled to a head tube of the bicycle, such that the fork body is configured to rotate relative to the head tube about an axis of rotation, wherein the fork body includes an upper portion configured to interface with an upper end of the head tube, a lower bearing surface configured to interface with a lower end of the head tube, and a front member configured to be disposed in front of a front surface of the head tube; and
a tension rod extending from the upper portion to the lower bearing surface, wherein the tension rod is configured to extend through an aperture of an inner wall of the head tube at a position offset from the axis of rotation, wherein the tension rod is configured to orbit around the axis of rotation with rotation of the fork body; and
wherein the aperture is configured to limit a range of orbital motion of the tension rod.

D1. The fork assembly of paragraph DO, further comprising a preload insert secured to the upper portion, wherein the preload insert is configured to preload headset bearings disposed at the upper end of the head tube.

D2. The fork assembly of paragraph D1, wherein an upper end of the tension rod is coupled to the preload insert and a lower end of the tensioning rod is coupled to the lower bearing surface.

D3. The fork assembly of any one of paragraphs D0-D2, wherein the upper portion is configured to be coupled to a handlebar stem of the bicycle.

D4. The fork assembly of any one of paragraphs D0-D3, further comprising one or more fork blades extending downward from a lower end of the fork body.

D5. The fork assembly of paragraph D4, wherein the fork body is configured to transmit torque from the upper portion to the fork blades to steer the bicycle.

D6. The fork assembly of any one of paragraphs D0-D5, wherein the fork assembly is formed as a single piece.

D7. The fork assembly of any one of paragraphs D0-D6, wherein the upper portion includes a first cable opening configured to receive one or more cables into an interior of the fork body.

D8. The fork assembly of any one of paragraphs D0-D7, wherein the upper portion includes a second cable opening configured to receive one or more cables into the head tube.

D9. The fork assembly of any one of paragraphs D0-D9, wherein the inner wall is oriented transverse to the axis of rotation.

E0. A fork assembly for a bicycle, the fork assembly comprising:
a C-shaped fork body configured to be coupled to a head tube of a bicycle, wherein the fork body includes an external front member spanning between an upper portion configured to interface with an upper end of the head tube and a lower bearing surface configured to interface with a lower end of the head tube; and
a tension rod extending from the upper portion to the lower bearing surface, wherein the external front member and the tension rod are disposed on opposite sides of an axis of rotation of the fork body.

E1. The fork assembly of paragraph E0, wherein the tension rod is configured to extend through an aperture of an inner wall of the head tube, and wherein the aperture is configured to limit a range of orbital motion of the tension rod.

E2. The fork assembly of paragraph E0 or E1, wherein the external front member and the tension rod are offset from the axis of rotation by different respective distances.

E3. The fork assembly of any one of paragraphs E0-E2, further comprising a preload insert secured to the upper portion, wherein the preload insert is configured to preload headset bearings disposed at the upper end of the head tube.

E4. The fork assembly of paragraph E3, wherein an upper end of the tension rod is coupled to the preload insert and a lower end of the tensioning rod is coupled to the lower bearing surface.

E5. The fork assembly of paragraph E4, wherein the lower end of the tensioning rod is threaded into the lower bearing surface.

E6. The fork assembly of any one of paragraphs E0-E5, wherein the upper portion comprises a mounting surface configured to be coupled to a handlebar stem of the bicycle.

E7. The fork assembly of any one of paragraphs E0-E6, further comprising one or more fork blades extending downward from a lower end of the fork body.

E8. The fork assembly of any one of paragraphs E0-E7, wherein the fork assembly is formed as a single piece.

E9. The fork assembly of any one of paragraphs E0-E8, wherein the upper portion includes a first opening configured to receive one or more hoses.

F0. A method of limiting the travel of a fork of a bicycle, wherein the method includes arresting rotation of the fork using the fork assembly of any one of A0 through E9 above.

### Advantages, Features, and Benefits

The different embodiments and examples of the fork assembly described herein provide several advantages over known solutions for fork assemblies having steer limiters. For example, illustrative embodiments and examples described herein allow for a fork assembly configured to facilitate internal routing of cables from a handlebar assembly to front and rear disk brake systems disposed on front and rear wheels of the bicycle. For example, an upper portion and/or preload insert of the fork assembly may have one or more apertures configured to receive cables into the hollow interior of the head tube of the bicycle and/or the hollow interior of fork assembly to be routed to the front or rear wheel of the bicycle.

Additionally, and among other benefits, illustrative embodiments and examples described herein allow a fork assembly having a steer limiting mechanism configured to limit a maximum rotation angle of the fork assembly relative to a head tube of the bicycle. The steer limiting mechanism may prevent oversteering by a rider of the bicycle and/or prevent damage of the fork assembly or bicycle frame caused by over rotation of the fork assembly.

Additionally, and among other benefits, illustrative embodiments and examples described herein allow an external steerer fork assembly configured to have improved handling performance.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A bicycle comprising:
a frame including a head tube;
a fork assembly coupled to the head tube and configured to rotate relative to the head tube about an axis of rotation, wherein the fork assembly includes:
a fork body having an upper portion interfaced with an upper end of the head tube, a lower bearing surface interfaced with a lower end of the head tube, and a front member connecting the upper portion and the lower bearing surface, the front member disposed forward of a front surface of the head tube; and
a tension rod extending from the upper portion to the lower bearing surface through an aperture of an inner wall of the head tube at a position offset from the axis of rotation, such that the tension rod is configured to move with rotation of the fork body;
wherein the inner wall is oriented transverse to the axis of rotation and the aperture is configured to limit a range of motion of the tension rod.

2. The bicycle of claim 1, further comprising a preload insert secured to the upper portion, wherein the preload insert is configured to preload headset bearings disposed at the upper end of the head tube.

3. The bicycle of claim 2, wherein an upper end of the tensioning rod is coupled to the preload insert and a lower end of the tension rod is coupled to the lower bearing surface.

4. The bicycle of claim 1, wherein the upper portion includes a mounting surface configured to be coupled to a handlebar stem of the bicycle.

5. The bicycle of claim 1, further comprising one or more fork blades extending downward from a lower end of the fork body.

6. The bicycle of claim 5, wherein the inner wall is adjacent a lower end of the head tube.

7. The bicycle of claim 1, wherein the fork assembly is formed as a single piece.

8. The bicycle of claim 1, wherein the aperture is an arcuate aperture.

9. The bicycle of claim 1, wherein the upper portion includes a first opening configured to receive one or more brake lines into an interior of the fork body.

10. The bicycle of claim 1, wherein the external front member and the tension rod are disposed on opposite sides of the axis of rotation.

11. A fork assembly for a bicycle, the fork assembly comprising:
a C-shaped fork body configured to be coupled to a head tube of a bicycle, wherein the fork body includes an external front member spanning between an upper portion configured to interface with an upper end of the head tube and a lower bearing surface configured to interface with a lower end of the head tube; and
a tension rod extending from the upper portion to the lower bearing surface, wherein the external front member and the tension rod are disposed on opposite sides of an axis of rotation of the fork body.

12. The fork assembly of claim 11, wherein the tension rod is configured to extend through an aperture of an inner wall of the head tube, and wherein the aperture is configured to limit a range of orbital motion of the tension rod.

13. The fork assembly of claim 11, wherein the external front member and the tension rod are offset from the axis of rotation by different respective distances.

14. The fork assembly of claim 11, further comprising a preload insert secured to the upper portion, wherein the preload insert is configured to preload headset bearings disposed at the upper end of the head tube.

15. The fork assembly of claim 14, wherein an upper end of the tension rod is coupled to the preload insert and a lower end of the tensioning rod is coupled to the lower bearing surface.

16. The fork assembly of claim 15, wherein the lower end of the tensioning rod is threaded into the lower bearing surface.

17. The fork assembly of claim 11, wherein the upper portion comprises a mounting surface configured to be coupled to a handlebar stem of the bicycle.

18. The fork assembly of claim 11, further comprising one or more fork blades extending downward from a lower end of the fork body.

19. The fork assembly of claim 11, wherein the fork assembly is formed as a single piece.

20. The fork assembly of claim 11, wherein the upper portion includes a first opening configured to receive one or more brake lines.
